(19) United States
(12) Patent Application Publication
(10) Pub. No.: US 2008/0151927 A1
(43) Pub. Date: Jun. 26, 2008

(54) Solution for attach peak

(75) Inventors: Jorma Peisalo, Vantaa (FI); Jarmo Virtanen, Espoo (FI); Antti Kangas, Oulunsalo (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: NOKIA CORPORATION

(21) Appl. No.: 12/003,308

(22) Filed: Dec. 21, 2007

Related U.S. Application Data
(60) Provisional application No. 60/876,487, filed on Dec. 22, 2006.

(51) Int. Cl. H04L 12/56

(52) U.S. Cl. 370/458

(57) ABSTRACT

The present invention relates to a method that provides for informing a terminal of an availability of access to a packet network. To this end, at a packet network element or a service entity, a timer value is set to a predetermined time period. Then, according to an embodiment, the packet network element signals an availability of packet switched services to a respective one of a plurality of service entities and delays signaling to a respective another one of the plurality of service entities by the predetermined time period. According to another embodiment, the signaling to a plurality of service entities is performed simultaneously. Then, the service entity indicates an availability of packet switched services to a respective one of a plurality of terminals and delays indicating to a respective another one of the plurality of terminals by the predetermined time period.

### CROSS REFERENCE TO RELATED APPLICATION

This application claims priority of U.S. Provisional Patent Application No. 60/876,487 filed on Dec. 22, 2006. The subject matter of the earlier filed application is hereby incorporated by reference.

### FIELD OF THE INVENTION

The present invention relates to the field of packet switched services in networks, and in particular to the attaching of terminals to a packet switched network. In this regard, the present invention relates to a corresponding method and network entities involved.

### BACKGROUND

For the purpose of the present invention to be described herein below, it should be noted that a network to which the present invention is applicable may for example be any kind of communication network irrespective of a specific standard, such as Global System for Mobile Communication (GSM), Universal Mobile Telecommunication System (UMTS), IS-95, or the like, or may be based on any known or future developed architecture, such as System Architecture Evolution (SAE) or Long Term Evolution (LTE), as long as the communication network is capable to handle packet switched services. It should also be noted that, for the network, any suitable protocol for operating/message exchange is possible.

Additionally, for the purpose of the present invention to be described herein below, it should be noted that method steps or actions performed in connection with the method, likely to be implemented as software code portions, and being run using a processor at one of the packet network element or service entities, are software code independent and can be specified using any known or future developed programming language as long as the functionality defined by the method steps or actions is preserved. Generally, any method step is suitable to be implemented as software, or by hardware, without changing the idea of the present invention in terms of the functionality implemented. Furthermore, any method steps and/or devices likely to be implemented as hardware components at one of the packet network elements, or service entities, are hardware independent and can be implemented using any known or future developed hardware technology or any hybrids of these, such as MOS (Metal Oxide Semiconductor), CMOS (Complementary MOS), BiCMOS (Bipolar CMOS), ECL (Emitter Coupled Logic), TTL (Transistor Transistor Logic), etc., using for example ASIC (Application Specific Integrated Circuit) components or DSP (Digital Signal Processor) components, as an example.

Additionally, for the purpose of the present invention to be described herein below, it should be noted that devices can be implemented as individual devices, but this does not exclude that they are implemented in a distributed fashion throughout the system, as long as the functionality of the device/system is preserved. Additionally, any respective elements, e.g. transceiver, setting unit etc. according to embodiments can be implemented by any known means, either in hardware (e.g. using DSP, microprocessor, microcontroller, ASIC, field programmable gate array (FPGA), AD- and DA-converters, power amplifiers, filters, antennas, etc.) and/or software, respectively, as long as it is adapted to perform the described functions of the respective parts.

In mobile networks, mobile terminals can move within network cells or between networks and mobile terminals that want to send or receive data have to be connected to a serving general packet radio service (GPRS) support node (SGSN). In order to accelerate an attachment procedure of the mobile terminals to the SGSN, some of the mobile terminals are provided with a so-called “always-on” functionality. That is, a terminal having the “always-on” functionality tries to autonomously attach to the packet switched network as soon as packet services are available. In case of an interruption of the services leading to a detach of the terminals, e.g. due to the loss of coverage, network failure, controlled restart of the network or the like, the terminals immediately attempt to re-attach to the packet switched network after the services are available again.

In current live mobile networks there can be several tens of thousands of terminals on the area of a single SGSN that are attached to the network, a considerable number of these utilizing the “always-on” functionality. Due to the increasing usage of packet switched services, the number of attached terminals is increasing all the time.

When the SGSN is restarted, e.g. because of software maintenance, fault or the like, and the access interface of a packet switched network goes down, the terminals lose the attachment to the packet switched network. After the SGSN is running again and the radio network signals the availability of the packet switched service to the mobile terminals, the previously attached mobile terminals having the “always-on” functionality activated start immediately to send attach requests towards the SGSN. However, this results in a problem in that this causes a huge peak of attach signaling as all the cells controlled by the SGSN re-gain the packet switched service capability almost simultaneously. This attach burst overloads core network elements in terms of processing capability or interface capacity, or both. Due to such a post-restart attach burst, a whole network may be inaccessible. Even if all network elements could handle the overload peak without crashing, it might take a long time before all attach requests are served. In practice it has been measured in live networks that it could take several hours before all attach requests are handled. This means that data services cannot be used during that time and operators unnecessarily lose revenue. In the worst case, the signaling peak might overload the home location register (HLR) so that the circuit switched services are also unavailable.

A solution for this problem would be to increase the signaling system 7 (SS7) links between the SGSN and the HLR to cope with the attach burst. However, preparing for attach overload by increasing the HLR interface capacity would cause significant extra costs, since the signaling peak to cope with is at least a hundred times bigger than that according to normal usage.

The above described problem becomes even bigger as the capacity of SGSNs is further increasing to one million terminals or more. Another issue making the problem worse is the increasing amount of terminals having the “always-on” functionality. In practice, almost all new third generation (3G) terminals are provided with this functionality.

According to a known method, radio network cells come up at different times, thereby spreading the attach requests of the terminals so that an attach peak is avoided. However, in live networks all cells are up and running within a couple of seconds. Therefore, there might be thousands of requests per second.

According to a further known method, terminals have a timer for resending attach requests if there is no answer to the requests. However, since all terminals use the same timer values this does not solve the above described problem, and continuous resending makes the problem even worse.

### SUMMARY

In accordance with an exemplary embodiment of the present invention there is provided a method and a corresponding packet network element and service entity for attaching terminals to a packet switched network.

In accordance with an exemplary embodiment of the present invention, there is provided a method, which includes setting, at a packet network element, a timer value to a predetermined time period. The method also includes signaling, from the packet network element, an availability of packet switched services to a plurality of service entities, and the signaling comprising informing a respective one of the plurality of service entities of the availability of packet switched services, and delaying informing, from the packet network element, the availability of packet switched services to a respective another one of the plurality of service entities by the predetermined time period.

According to another exemplary embodiment of the present invention, there is provided a packet network element, which includes a setting unit configured to set a predetermined time period, and a signaling unit configured to signal an availability of packet switched services to a plurality of service entities. The packet network element also includes a delaying unit configured to delay the operation of the signaling unit by the predetermined time period, and the signaling unit is further configured to inform a respective one of the plurality of service entities of the availability of packet switched services, and to inform a respective another one of the plurality of service entities after the predetermined time period.

According to another exemplary embodiment of the present invention, there is provided a method, which includes signaling, from a packet network element, an availability of packet switched services to a plurality of service entities. The method also includes initializing the service entity to which the availability is signalled, and setting, at the plurality of service entities, a timer value to a predetermined time period. The method also includes indicating, by the plurality of service entities, the service availability to a plurality of terminals, the indicating comprising informing a respective one of the plurality of terminals of the availability of packet switched services, and delaying informing, by the plurality of service entities, the service availability to a respective another one of the plurality of terminals by the predetermined time period.

According to another exemplary embodiment of the present invention, there is provided a service entity, including a receiving unit configured to receive signaling of an availability of packet switched services from a packet network element, and a setting unit configured to set a predetermined period of time. The service entity also includes an indicating unit configured to indicate the availability of packet switched services to a plurality of terminals, and a delaying unit configured to delay the operation of the indicating unit by the predetermined time period, the indicating unit being further configured to inform a respective one of the plurality of terminals of the availability of packet switched services, and to inform a respective another one of the plurality of terminals after the predetermined time period.

According to another exemplary embodiment of the present invention, there is provided a packet network element, which includes setting means for setting a predetermined time period, and signaling means for signaling an availability of packet switched services to a plurality of service entities. The packet network element also includes delaying means for delaying the operation of the signaling means by the predetermined time period, and the signaling means further informs a respective one of the plurality of service entities of the availability of packet switched services, and informs a respective another one of the plurality of service entities after the predetermined time period.

According to another exemplary embodiment of the present invention, there is provided a service entity, which includes receiving means for receiving signaling of an availability of packet switched services from a packet network element, and setting means for setting a predetermined period of time. The service entity also includes indicating means for indicating the availability of packet switched services to a plurality of terminals, and delaying means for delaying the operation of the indicating means by the predetermined time period, the indicating means further informs a respective one of the plurality of terminals of the availability of packet switched services, and informs a respective another one of the plurality of terminals after the predetermined time period.

### BRIEF DESCRIPTION OF THE DRAWINGS

At least some exemplary embodiments of the present invention are described herein below by way of example with reference to the accompanying drawings, wherein:

FIG. 1 is an overview of a mobile network to which the embodiments of the present invention are applicable;

FIG. 2 is a signaling diagram illustrating an attach process according to the first embodiment of the present invention;

FIG. 3 is a signaling diagram illustrating an attach process according to the second embodiment of the present invention;

FIG. 4 is a block diagram of a packet network element according to the first embodiment of the present invention;

FIG. 5 is a block diagram of a service entity according to the second embodiment of the present invention;

FIG. 6 is an overview of the attach process according to a specific example of the first embodiment of the present invention.

### DETAILED DESCRIPTION OF EMBODIMENTS

Reference will now be made to the embodiments of the present invention. Examples of the embodiments are illustrated in the accompanying drawings.

In the figures, individual steps can be merged to be executed simultaneously, or partitioned to sub-steps to be executed sequentially, without essentially modifying the substance of the invention.

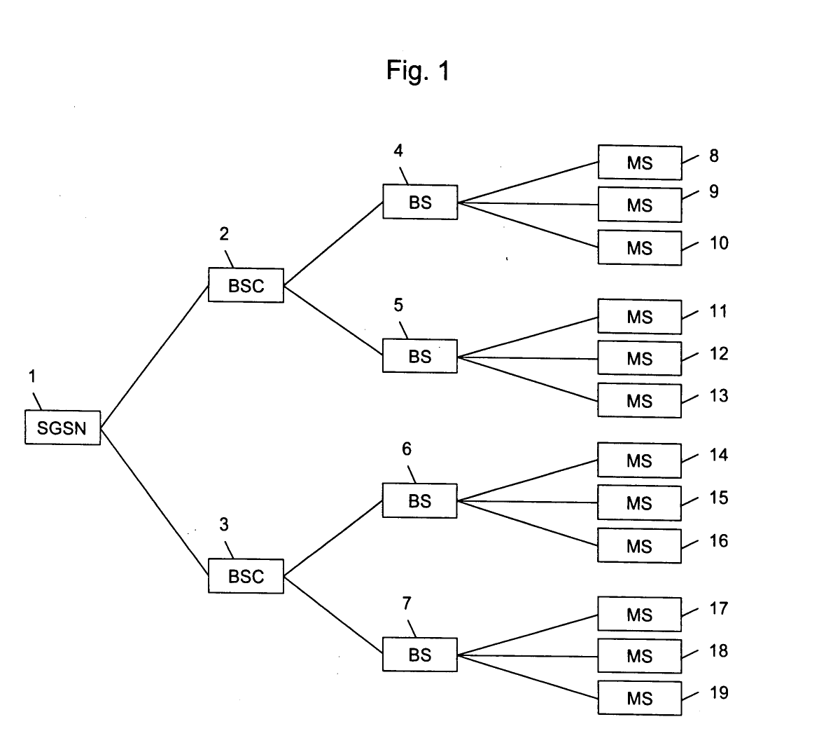

FIG. 1 shows a basic overview of a packet network according to embodiments of the present invention. A packet network to which embodiments of the present invention are applicable comprises a SGSN 1, a plurality of base station controllers BSC 2 and 3, a plurality of base stations BS 4 to 7, and a plurality of terminals MS 9 to 19. The terminals MS 9 to 19 all have the above mentioned “always-on” functionality. According to FIG. 1, two base station controllers BSC 2 and 3 are connected to a single SGSN 1. The base stations BS 4 and 5, and the base stations BS 6 and 7 are connected to the base station controllers BSC 2 and 3, respectively. To each of the base stations BS 4 to 7, a plurality of terminals MS is connected, thereby forming respective cells, e.g. BS 4 and MSs 8 to 10, BS 5 and MSs 11 to 13, BS 6 and MSs 14 to 16, and BS 7 and MSs 17 to 19.

For clarity, only a limited number of these network elements is shown. However, it has to be noted that the number of the elements is not limited to the number shown in FIG. 1, but can be any suitable number.

For the purpose of the examples of the embodiment of the present invention to be described herein below, the service entity (SE) is assumed to be incorporated into the BSCs. Thus, when referring to the BSC, it is also referred to the service entity. However, it has to be noted that the service entity can also be provided separately from the BSC, the BSC and the service entity being able to communicate with each other in order to perform according to the above described embodiments.

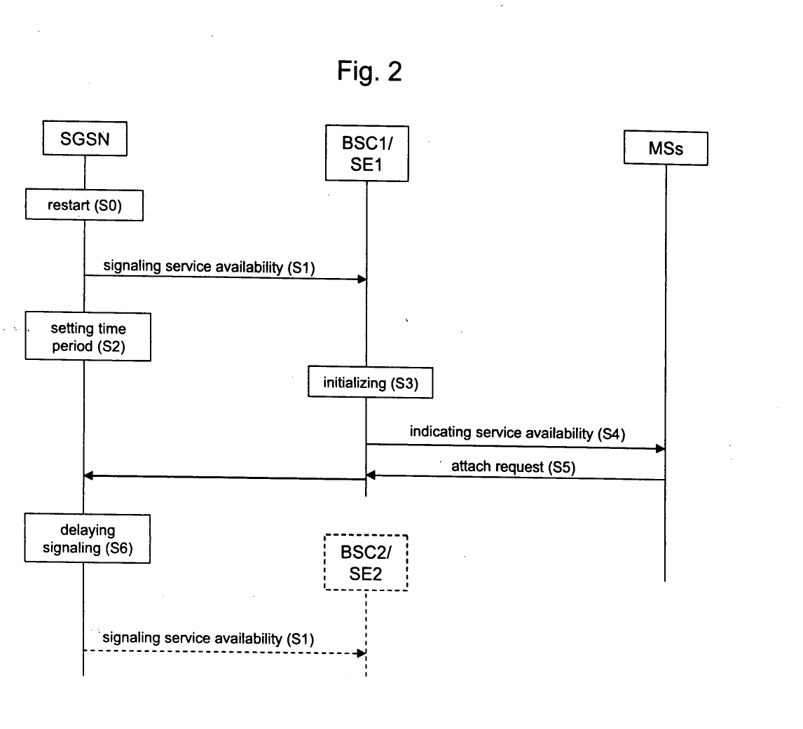

In the following, different embodiments of the procedure for attaching mobile stations to a packet switched network will be described with reference to FIGS. 2 to 5.

### First Embodiment

FIG. 2 is a signaling diagram illustrating the attach process according to the first embodiment of the present invention. After the restart of the SGSN at step S0, e.g. due to software maintenance or fault, the SGSN signals to the first BSC1 that the packet switched services are available again and then sets a predetermined time period at step S2. The predetermined time period can be a fixed value or can be set e.g. by an operator. After receiving the signaling from the SGSN, at step S3, the BSC1 is initialized and indicates the service availability at step S4 via the base stations (not shown) to the terminals MSs that are to be served by the BSC1. Then, the terminals MSs having the “always-on” functionality immediately send respective attach requests via the base stations and the BSC1 to the SGSN.

Then, at step S6 the signaling is delayed for the predetermined time period set in step S2. After the elapse of the predetermined time period, the procedure proceeds with the signaling of the service availability to a second BSC2 and the same steps S1 to S5 as described above are performed. Thus, the above described steps are repeated for each BSC connected to the SGSN.

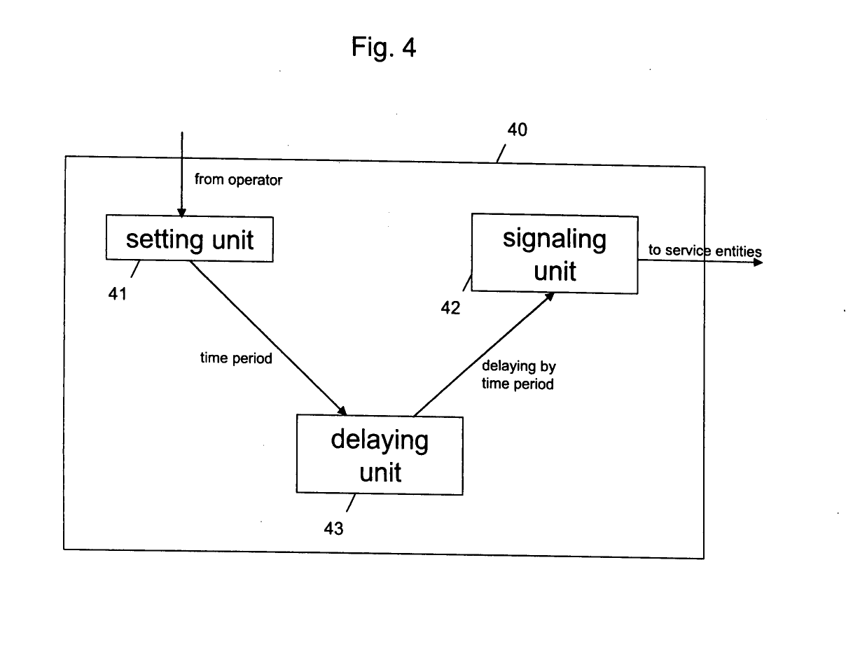

In the following, the packet network element of the packet network according to the first embodiment of the present invention will be described in detail with reference to FIG. 4.

FIG. 4 is a block diagram of a packet network element network according to the first embodiment of the present invention. The packet network element 40, e.g. a SGSN, according to the first embodiment comprises a setting unit 41. According to an example, the setting unit 41 receives an instruction from an operator and sets the predetermined time period according to this instruction. As an alternative, according to another example, the setting unit 41 is provided with a fixed timer value at installation or production of the packet network element and sets the time period accordingly. The packet network element further comprises a signaling unit 42. The signaling unit 42 signals the service entities, e.g. the BSCs, when packet switched services are available. Additionally, the packet network element comprises a delaying unit 43 connected to the setting unit 41 and the signaling unit 42. The delaying unit 43 obtains the predetermined time period from the setting unit 41 and then delays the operation of the signaling unit 42 by the predetermined time period.

Thus, according to this embodiment, the problem of a huge peak of attach signaling is avoided since all the cells controlled by the SGSN re-gain the packet switched service at different times.

### Second Embodiment

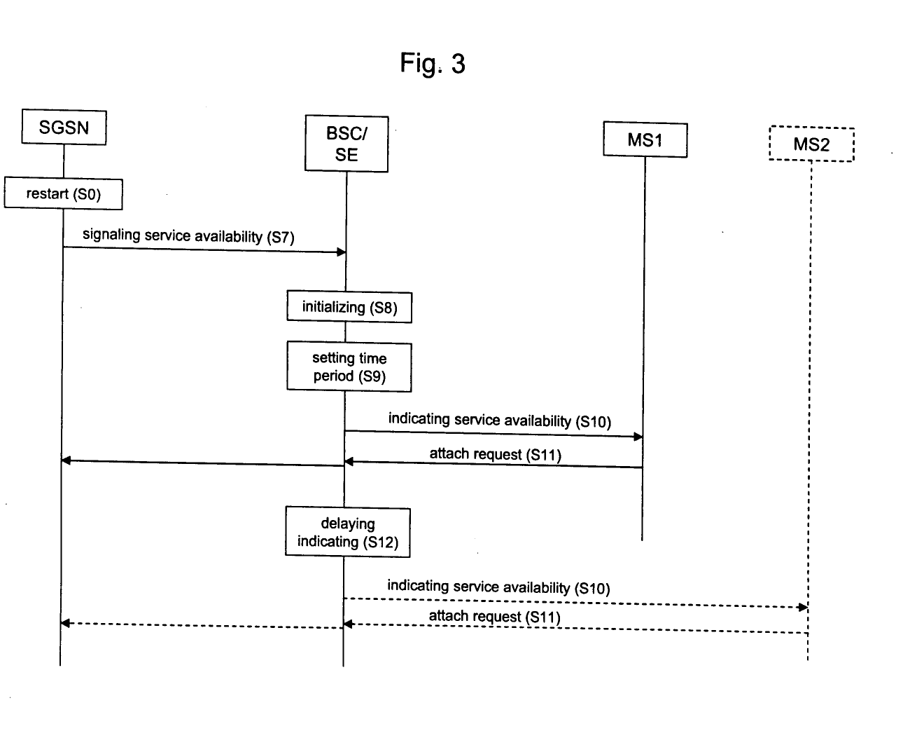

FIG. 3 is a signaling diagram illustrating the attach process according to the second embodiment of the present invention. After the restart of the SGSN at step S0, e.g. due to software maintenance or fault, at step S7, the SGSN signals to all BSCs connected to the SGSN that the packet switched services are available again. After receiving the signaling from the SGSN, at step S8 the BSCs are initialized. Then, at step S9, the BSCs set a predetermined time period and indicate the service availability at step S10 via the base stations (not shown) to a first terminal MS1 that is to be served by the respective BSC. The predetermined time period can be a fixed value or can be set e.g. by an operator. Then, at step S11, the first terminal MS1 having the “always-on” functionality immediately sends an attach requests via the base station and the BSC to the SGSN.

Then, at step S12 the indicating is delayed for the predetermined time period set in step S9. After the elapse of the predetermined time period, the procedure proceeds with the indicating of the service availability to a second terminal MS2 which also immediately sends an attach request to the SGSN. The above described steps S10 to S12 are then repeated for each terminal connected to the BSC. It has to be noted that the indicating of the service availability can also be effected to a group of terminals instead to a single terminal.

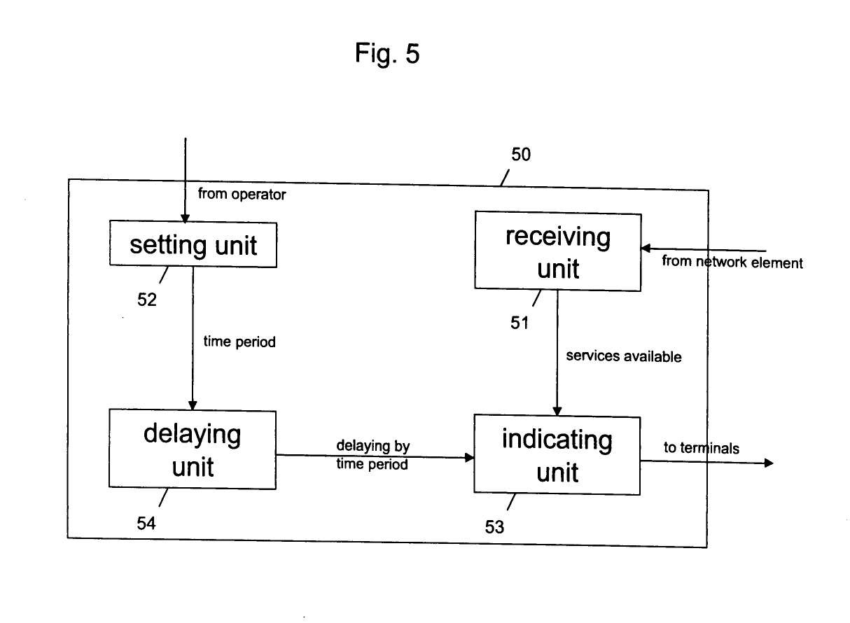

In the following, the service entity of the packet network according to the second embodiment of the present invention will be described in detail with reference to FIG. 5.

FIG. 5 is a block diagram of a service entity according to the second embodiment of the present invention. The service entity 50, e.g. the BSC, according to the second embodiment comprises a receiving unit 51 to receive signaling from the packet network element that packet switched services are available. The service entity 50 further comprises an indicating unit 53 connected to the receiving unit 51. The indicating unit 53 receives information from the receiving unit 51 that the services are available and indicates the availability of the services to the terminals connected to the service entity 50 via respective base stations (not shown). The service entity 50 further comprises a setting unit 52. According to an example, the setting unit 52 receives an instruction from an operator and sets the predetermined time period according to this instruction. As an alternative, according to another example, the setting unit 52 is set with fixed timer value at installation or production of the service entity and sets the time period accordingly. Furthermore, the service entity comprises a delaying unit 54 connected to the setting unit 52 and the indicating unit 53. The delaying unit 54 obtains the predetermined time period from the setting unit 52 and then delays the operation of the indicating unit 53 by the predetermined time period.

Thus, according to this embodiment, the problem of a huge peak of attach signaling is avoided since all the terminals controlled by the SGSN re-gain the packet switched service at different times.

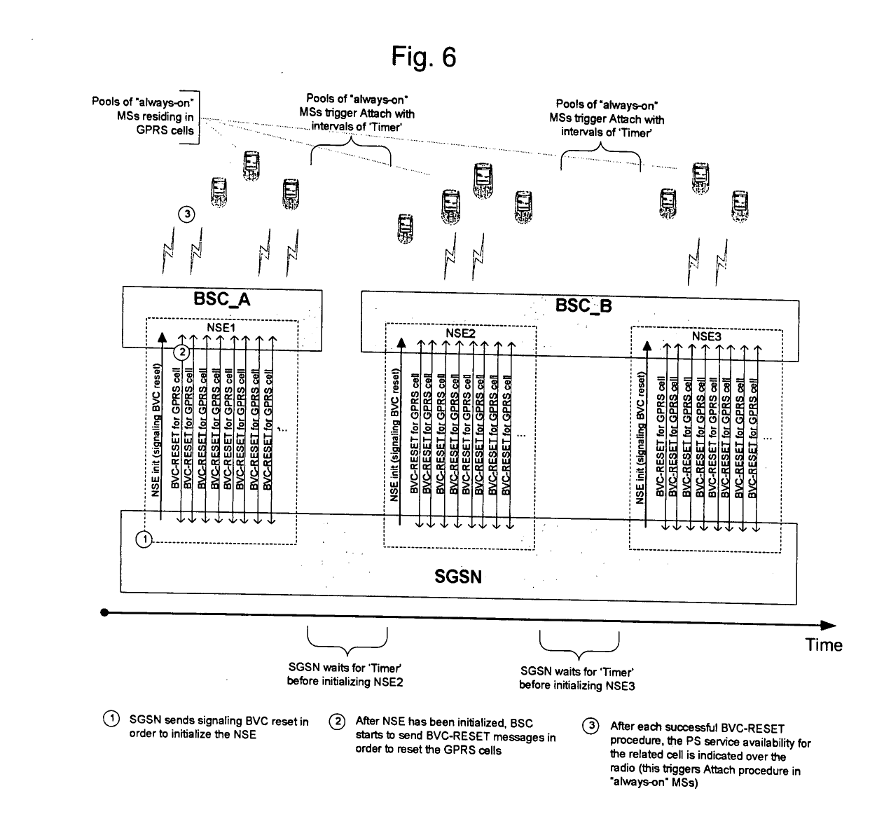

In the following, a specific example of the above described first embodiment will be illustrated with reference to FIG. 6.

According to FIG. 6, a SGSN is connected to a base station controller BSC_A and a base station controller BSC_B, the BSC_A and BSC_B serving respective pools of mobile stations MS via respective base stations (not shown). Further, FIG. 6 shows network service entities NSE1 to NSE3, wherein NSE1 is provided for BSC_A and NSE2 and NSE3 are provided for BSC_B.

In the following description, the term reset means that after a fault or the like, the network elements and entities are again able to operate according to their designated functions.

According to the specific example of the first embodiment, the SGSN has been provided with a Timer value. After a reset, the SGSN sends a signaling base station subsystem GPRS protocol (BSSGP) virtual connection (BVC) reset to the NSE1 in order to initialize the NSE1. When the NSE1 has been initialized, the BSC_A starts to send BVC-RESET messages towards the SGSN in order to reset GPRS cells. After each successful BVC-RESET, the GPRS cell is considered to be capable for packet services, and this is indicated to the terminals MS residing in the cell. As soon as the MSs gain packet services, the “always-on” MSs send respective attach requests towards the SGSN.

After sending a signaling BVC reset to the NSE1, the SGSN does not immediately initialize the NSE2 but waits for the duration of Timer. It is only after the Timer expires, that a signaling BVC reset is sent to NSE2 which, similarly to NSE1, triggers GPRS cell creation between BSC_B and SGSN. Consequently, the MSs residing in the respective cell send attach requests towards the SGSN. In the same way, SGSN waits the Timer duration before initializing NSE3 as it does also for the remaining NSEs.

As the radio network cells regain the packet service capability with adequate intervals leading to MSs performing re-attaches over wider time-period, the signaling overload caused by re-attaches is reduced to an unnoticeable level.

This example describes a case using the A/Gb mode. However, in Iu mode, the functionality is in principle the same. The 3G SGSN staggers the sending of radio access network application part (RANAP) RESET messages or other applicable interface initialization messages to radio network controllers (RNCs).

Although the foregoing description has been focused on 2^{nd} generation packet switched networks, the present invention also applies to other packet switched networks, like for example 3^{rd} generation packet switched networks or other currently existing or future developed network architectures like, e.g. System Architecture Evolution (SAE) and Long Term Evolution (LTE), as defined by the 3^{rd} Generation Partnership Project (3GPP), or the like.

According to at least one embodiment of the present invention, there is provided a better end-user service quality and costs are saved, because there is no need to over-dimension the SS7 link capacity for the worst peak load amounts. Further, according to at least one embodiment of the present invention, the network is usable (and generates revenue for the operator) immediately after the SGSN is restarted so that the user of the terminal gets the service much faster after the services are available. Thus, the long lasting congestion situations after the SGSN restart are avoided.

The method according to the embodiments of the present invention does not necessarily require standardization and is easy and fast to take into use. As a further advantage, the method of the present invention is independent of the terminal software and applies equally to new and old terminals having the “always-on” functionality.

In view of the foregoing description it will be evident to a person skilled in the art that various modifications may be made within the scope of the invention.

1. A method, comprising:
setting, at a packet network element, a timer value to a predetermined time period;
signaling, from the packet network element, an availability of packet switched services to a plurality of service entities,
the signaling further comprising informing a respective one of the plurality of service entities of the availability of packet switched services; and
delaying informing, from the packet network element, the availability of packet switched services to a respective another one of the plurality of service entities by the predetermined time period.

2. The method according to claim 1, further comprising initializing the service entity to which the availability is signaled.

3. The method according to claim 2, further comprising indicating, by the service entity, the service availability to a terminal.

4. The method according to claim 3, further comprising sending, by the terminal, an attach request to the packet network element via the service entity.

5. A packet network element, comprising:
a setting unit configured to set a predetermined time period;
a signaling unit configured to signal an availability of packet switched services to a plurality of service entities; and
a delaying unit configured to delay the operation of the signaling unit by the predetermined time period,
the signaling unit being further configured to inform a respective one of the plurality of service entities of the availability of packet switched services, and to inform a respective another one of the plurality of service entities after the predetermined time period.

6. A method, comprising:
signaling, from a packet network element, an availability of packet switched services to a plurality of service entities;
initializing the service entity to which the availability is signaled;
setting, at the plurality of service entities, a timer value to a predetermined time period;
indicating, by the plurality of service entities, the service availability to a plurality of terminals,
the indicating further comprising informing a respective one of the plurality of terminals of the availability of packet switched services; and
delaying informing, by the plurality of service entities, the service availability to a respective another one of the plurality of terminals by the predetermined time period.

7. The method according to claim 6, further comprising sending, by the terminal, an attach request to the service entity.

8. A service entity, comprising:
a receiving unit configured to receive signaling of an availability of packet switched services from a packet network element;
a setting unit configured to set a predetermined period of time;
an indicating unit configured to indicate the availability of packet switched services to a plurality of terminals; and
a delaying unit configured to delay the operation of the indicating unit by the predetermined time period,
the indicating unit being further configured to inform a respective one of the plurality of terminals of the availability of packet switched services, and to inform a respective another one of the plurality of terminals after the predetermined time period.

9. A packet network element, comprising:
setting means for setting a predetermined time period;
signaling means for signaling an availability of packet switched services to a plurality of service entities; and
delaying means for delaying the operation of the signaling means by the predetermined time period,
the signaling means further informing a respective one of the plurality of service entities of the availability of packet switched services, and informing a respective another one of the plurality of service entities after the predetermined time period.

10. A service entity, comprising:
receiving means for receiving signaling of an availability of packet switched services from a packet network element;
setting means for setting a predetermined period of time;
indicating means for indicating the availability of packet switched services to a plurality of terminals; and
delaying means for delaying the operation of the indicating means by the predetermined time period,
the indicating means further informing a respective one of the plurality of terminals of the availability of packet switched services, and informing a respective another one of the plurality of terminals after the predetermined time period.
